(19) United States
(12) Patent Application Publication
(10) Pub. No.: US 2026/0028359 A1
(43) Pub. Date: Jan. 29, 2026

(54) OXYGEN-SELECTIVE ADSORPTION FROM AIR WITH A METAL-ORGANIC FRAMEWORK FEATURING OPEN COPPER SITES

(71) Applicant: THE REGENTS OF THE UNIVERSITY OF CALIFORNIA, Oakland, CA (US)

(72) Inventors: Jeffrey R. Long, Lafayette, CA (US); Kurtis M. Carsch, Berkeley, CA (US)

(73) Assignee: THE REGENTS OF THE UNIVERSITY OF CALIFORNIA, Oakland, CA (US)

(21) Appl. No.: 19/341,778

(22) Filed: Sep. 26, 2025

Related U.S. Application Data
(63) Continuation of application No. PCT/US2024/025589, filed on Apr. 19, 2024.
(60) Provisional application No. 63/460,810, filed on Apr. 20, 2023.

(51) Int. Cl. C07F 1/08; B01D 53/04; B01J 20/22

(52) U.S. Cl. CPC C07F 1/08; B01D 53/04; B01J 20/226; B01D 2253/204; B01D 2256/18; B01D 2257/102; B01D 2257/104

(57) ABSTRACT

Metal organic framework compositions and methods for O₂ gas separations from ambient air and Ar gas stream purifications are provided. The metal-organic framework has the formula of Cu_{X}-MFU-4l, where X=2.2-2.7 and MFU=Metal- Organic Framework Ulm #4, large with optimized performance for Cu_{2.7}-MFU-4l, (Cu_{2.7}Zn_{2.3}H_{0.4}Cl_{0.9}(btdd)₃). The frameworks adsorb O₂ from ambient air in the presence of water with both excellent cyclability and rapid adsorption and desorption kinetics. Differences in the kinetics of O₂ and N₂ desorption following adsorption allow for isolation of high-purity O₂ following desorption, offering high-purity O₂ without costly, multi-step separations. The framework Cu_{2.7}-MFU-4l is further able to remove both N₂ and O₂ impurities from Ar streams.

### CROSS-REFERENCE TO RELATED APPLICATIONS

This application claims priority to, and is a 35 U.S. C. § 111(a) continuation of, PCT international application number PCT/US2024/025589 filed on Apr. 19, 2024, incorporated herein by reference in its entirety, which claims priority to, and the benefit of, U.S. provisional patent application Ser. No. 63/460,810 filed on Apr. 20, 2023, incorporated herein by reference in its entirety. Priority is claimed to each of the foregoing applications.

The above-referenced PCT international application was published as PCT International Publication No. WO 2024/220942 A1 on Oct. 24, 2024, which publication is incorporated herein by reference in its entirety.

### STATEMENT REGARDING FEDERALLY SPONSORED RESEARCH OR DEVELOPMENT

This invention was made with Government support under Grant No. DE-SC0019992 and under Contract No. DE-AC02-05CH11231, both awarded by the United States Department of Energy. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F. R. § 1.14.

### BACKGROUND

### 1. Technical Field

The technology of this disclosure pertains generally to methods and compositions for gas separations and capture and more particularly to an O₂-selective metal-organic framework family with formula of Cu_{X}-MFU-4l, where X=2.2-2.7 with optimized performance shown for Cu_{2.7}-MFU-4l, (Cu_{2.7}Zn_{2.3}H_{0.4}Cl_{0.9}(btdd)₃). The frameworks can reversibly recover O₂ from ambient air or from composite gas streams at 25°C with no evidence of degradation over repeated adsorption-desorption cycles.

### 2. Background Discussion

Enriched-O₂ or high-purity O₂ gases are critical commodities in medical, manufacturing and aerospace industries as well as for the production of feedstock chemicals such as ethylene oxide and phthalic anhydride. The vast majority of this oxygen gas is typically produced from the cryogenic distillation of air that uses a multistep process. Industrial air separation processes typically involve air compression and pre-treatment with molecular sieves and activated alumina to remove volatile organic compounds, water, and carbon dioxide that require capital and energy intensive infrastructure prior to the O₂/N₂ separation. Moreover, periodic regeneration of these sorbents through temperature and pressure swings is necessary following deactivation from saturation.

Subsequent gas expansion and cooling through a series of heat exchangers allows for cryogenic distillation based on subtle differences in vapor pressures between O₂ (90 K boiling point, 21% stream composition), N₂ (77 K, 78%), and Ar (87 K, 1%). The O₂-deplete gas stream is further subject to secondary purifications to separate N₂ from Ar. Failures in the initial purification stage have resulted in large-scale catastrophic events attributed to uncontrolled oxidation of combustible impurities in the cryogenic distillation unit. Such failures provide motivation for alternative lower risk and energy-efficient non-cryogenic methods of O₂ purification.

While cryogenic distillation is the most mature and widely-used technology for air separations, identifying more energy-efficient and scalable methods for isolating O₂ from air is of major interest. An optimized porous material capable of selectively capturing O₂ over N₂ and the other components of air such as water could in principle be used to produce high purity O₂ in a simple and efficient process requiring no air pre-treatment, thus minimizing the total number of unit operations, the need for periodic regeneration of these sorbents, and ultimately the size of capital expenditures. Such a process would also require far less adsorbent than is needed for air separations using N₂-selective zeolites, given that the concentration of O₂ (21%) in air is much less than the concentration of N₂ (78%). However, the majority of MOFs studied to date for O₂ capture only adsorb appreciable O₂ at sub-ambient temperatures or exhibit poor stability to repeated cycling. Additionally, few studies have investigated the impact of relative humidity on adsorbent stability and O₂ capacity in this context.

A renaissance in this area has occurred within the last few years with the discovery that certain porous, microcrystalline metal-organic frameworks (MOFs) featuring coordinatively unsaturated metal sites can adsorb O₂ via electron transfer mechanisms that endow them with excellent selectivity for O₂over N₂. Importantly, adsorptive air separations using cation-exchanged zeolites that selectively adsorb N₂ over O₂ (and Ar) are already widely used in industry to supplement cryogenic distillation for applications where O₂ purities <95% are sufficient in circumstances such as for medicinal deployment. As such, infrastructure is in place that could in principle be readily adapted to implement separations technology using O₂-selective adsorbents.

Whereas polymeric membrane oxygen concentrators allow for the production of an O₂-enriched permeates at ambient temperatures, the similar solubilities and kinetic diameters of O₂ and N2 limit the purity of recovered O₂. In contrast, porous adsorbents can produce high-purity O₂ and have emerged as leading candidates for the binary separation of O₂ from N₂.

The cation-exchanged zeolites preferentially ligate N₂ over O₂ based on quadrupole moments. However, the greater fraction of N₂ over O₂ in air and the potential for gas stream impurities render N₂-selective adsorption less ideal for air purification compared to O₂-selective adsorption.

Microcrystalline metal-organic frameworks (MOFs) containing coordinatively unsaturated metal sites (e.g., Fe²⁺, Cr²⁺, Co²⁺) offer promise for O₂ selectivity based commonly on O₂ redox engagement. Unfortunately, many of these frameworks require sub-ambient temperatures for appreciable O₂ uptake, exhibit poor cyclability, and exhibit a high affinity for trace H₂O vapor based on the hard divalent nature of the metal cation and the presence of microporous cavities. Accordingly, there is a need for engineered O₂-selective sorbents that can tolerate airborne water vapor and can operate with mild temperature swings at ambient conditions and provide substantial capital and energy savings over current processes.

### BRIEF SUMMARY

Metal organic framework compositions and methods for O₂ gas separations from ambient air and Ar gas stream purifications are provided.

The metal-organic framework has the general formula of Cu_{X}-MFU-4l, where X=2.2-2.7 and MFU=Metal-Organic Framework Ulm #4, large with optimized performance illustrated with Cu_{2.7}-MFU-4l, (Cu_{2.7}Zn_{2.3}H_{0.4}Cl_{0.9}(btdd)₃). The frameworks have been shown to adsorb O₂ from ambient air in the presence of water with both excellent cyclability and rapid adsorption and desorption kinetics. Differences in the kinetics of O₂ and N₂ desorption following adsorption allow for isolation of high-purity O₂ following desorption, offering high-purity O₂ without costly, multi-step separations. The framework Cu_{2.7}-MFU-4l is further able to remove both N₂ and O₂ impurities from Ar streams.

The MFU-4l (Cu_{2.7}Zn_{2.3}H_{0.4}Cl_{0.9}(btdd)₃), Cu^{I}-MFU-4l framework recovers O₂ from ambient air at 25° C. reversibly with no evidence of degradation over repeated cycling. Importantly, differences in desorption kinetics for O₂ and N₂allow for isolation of high-purity O₂ from a kinetic separation. Excellent water stability allows for repeated cycling without capacity losses, enabling the use of exceptionally mild regeneration conditions at either 25° C. or 50°C. as evident by breakthrough measurements. Spectroscopic and computational investigations of O₂ coordination reveal temperature-dependent binding modes, furnishing desirable adsorption and desorption kinetics as well as binding thermodynamics. The MOF examples provide a first demonstration of frameworks providing efficient recovery of high-purity O₂ from unpurified, ambient air.

An in-depth analysis of the O₂ adsorption properties of Cu^{I}-MFU-4l using gas adsorption, spectroscopic, and breakthrough analyses was conducted. It is shown that Cu^{I}-MFU-4l adsorbs O₂ from ambient air in the presence of water with both excellent cyclability and rapid adsorption and desorption kinetics. Strong but reversible binding of O₂ is attributed to variable temperature-influenced binding modes to the exposed CuI site. Differences in the kinetics of O₂ and N₂ desorption following adsorption allow the isolation of high-purity O₂ following desorption, producing high-purity O₂.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a plot of isosteric heats of adsorption for O₂, N₂, and Ar, revealing the most enthalpically favored binding for O₂.

FIG. 2 is a plot of variable temperature selectivity calculations for a binary O₂/N₂ mixture with O₂ concentration in air (21%) highlighted (vertical line). Predicted selectivity values as a function of temperature and O₂ concentration, revealing enhanced purity upon exposure to the MOF.

FIG. 3 is a plot of predicted selectivity values of N₂/Ar and O₂/Ar (inset), indicating opportunities to purify inlet Ar streams.

FIG. 4 is plot of single-component water isotherms, revealing the novel material (Cu_{2.7}) shows lower water uptake and better stability than incumbent technology (Cu_{2.2}) from literature syntheses.

FIG. 5 is a plot of desorption profiles for N₂ and O₂ under a simulated temperature and pressure swing, revealing a more gradual release of O₂ and allowing for a kinetic desorption. Differences in desorption allow for a kinetic separation to achieve O₂ without N₂.

### DETAILED DESCRIPTION

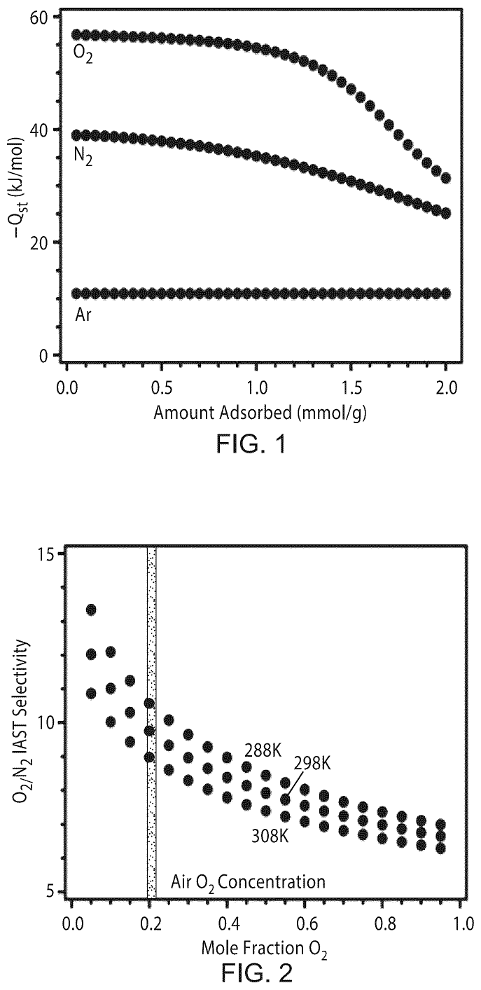

Referring more specifically to the drawings, for illustrative purposes, compositions, materials and methods for the capture and recovery of high-purity O₂ from air or composite gas streams are generally shown. Several embodiments of the technology are described generally in FIG. 1 to FIG. 5 to illustrate the characteristics and functionality of the for snapshot hyperspectral microscope apparatus and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

An O₂-selective metal-organic framework Cu_{2.7}-MFU-4l (Cu_{2.7}Zn_{2.3}H_{0.4}Cl_{0.9}(btdd)₃), Cu^{I}-MFU-4l that can recover O₂ from ambient air at 25°C reversibly with no evidence of degradation over repeated cycling is presented. The O₂ adsorption properties of Cu^{I}-MFU-4l using gas adsorption, spectroscopic, and breakthrough analyses are demonstrated. The Cu^{I}-MFU-4l composition is shown to adsorb O₂ from ambient air in the presence of water with both excellent cyclability and rapid adsorption and desorption kinetics. Strong but reversible binding of O₂ is attributed to variable temperature-influenced binding modes to the exposed CuI site. Differences in the kinetics of O₂ and N₂ desorption following adsorption allow for the isolation of high-purity O₂ following desorption, offering high-purity O₂.

The Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin) composition features pentanuclear cluster nodes of a central octahedral Zn(II) ion coordinated to four peripheral metal ions—either pyramidalized Cu(I) or tetrahedral Zn(II) with either formate or chloride ligation. The framework has been shown to reversibly bind O₂ and N₂ at its copper(I) sites, and the favorable calculated ΔG of O₂ binding in this material makes it suitable for O₂-selective adsorptive air separations.

Single-component isotherms of O₂, N₂, and Ar collected at 25° C. reveal Cu^{I}-MFU-4l composition adsorbs more O₂ compared to N₂ and Ar for all pressures below 1 bar. At the fractional composition of air (ca. 210 mbar O₂, 780 mbar N₂, 9 mbar Ar), the O₂ capacity (1.51 mmol/g) exceeds that of N₂ (1.30 mmol/g) and of Ar (<0.01 mmol/g), suggesting preferential adsorption of O₂. Selectivity values estimated with ideal adsorption solution theory (IAST) reveal enhancement O₂ in the adsorbed phase with an isosteric heat of adsorption (Qst) as calculated by the Clausius-Clapeyron equation for O₂ (−56.8 kJ/mol) exceeding those of N₂ (−38.9 kJ/mol) and Ar (−10.9 kJ/mol), (FIG. 1). Similar Ar heats of adsorption values (−10 to −12 kJ/mol) have been observed for zeolites and activated carbons, suggesting weak framework interactions. An O₂/N₂ IAST value of 10 (72% adsorbed phase purity) was predicted at 298 K for an inlet stream of 21% O₂, where lowering the temperature affords a slight increase in purity (74% adsorbed phase purity). It was noted that kinetic differences arising from electron transfer may result in deviations from expectations for multicomponent mixtures, limiting the applicability of IAST in realistic conditions.

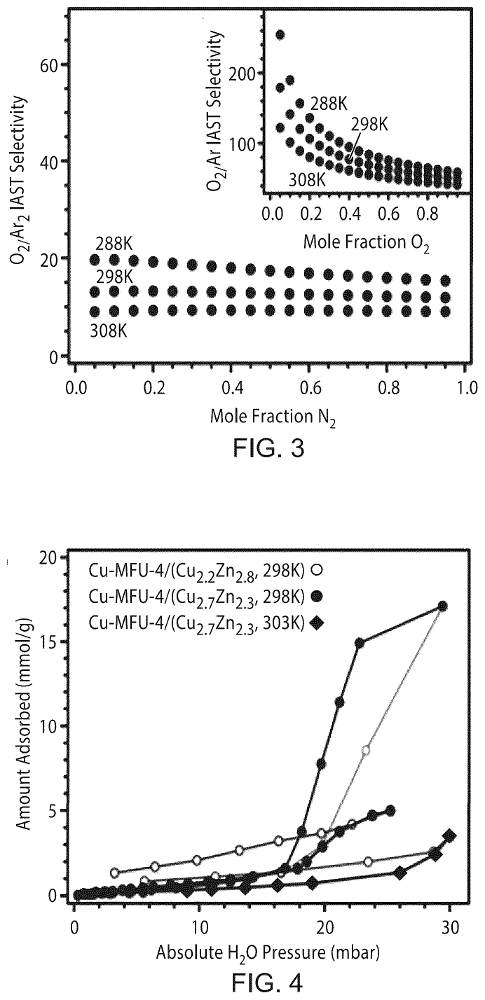

Single-component Ar isotherms at 25°C revealed a minimal uptake with 0.22 mmol/g uptake at 1 bar, suggestive of high selectivity for O₂ over both Ar and N₂, indicating CuI-MFU-4l should be appropriate to remove N₂ and O2 impurities for Ar purification (FIG. 3). No affinity for other components of air was expected. Single-component water isotherms revealed the material has a minimal affinity for water.

Furthermore, in comparison to literature syntheses of Cu^{I}-MFU-4l, synthesis methods reported herein exhibit substantially improved water stability (FIG. 4). Moreover, cycling measurements with Cu^{I}-MFU-4l reveal rapid adsorption and desorption kinetics.

Thermogravimetric analysis with brief adsorption with desiccated air (5 min) and desorption under simulated vacuum with an Ar purge (10 min) reveal >99.5% capacity retention over 120 cycles, indicating robustness to adsorption and desorption in a pressure swing adsorption process. Similarly, partial O₂ desorption could be achieved through a thermal swing adsorption process by heating the framework to 100° C. for 30 seconds with majority capacity retention (>95%) over 40 cycles with the slight capacity decrease attributable due to the highly oxidizing conditions. Under pure O₂, framework retention was observed until 280° C., indicating excellent oxidative robustness.

Kinetic measurements revealed that N₂ coordination occurs more rapidly than O₂ at lower partial pressures. Nonetheless, in the presence of excess gas, kinetic differences were minimized. More sluggish desorption kinetics were observed for O₂ relative to N₂, providing an opportunity for a kinetic separation.

Breakthrough measurements at 25° C. with a compressed air inlet stream (2 mL min⁻¹) were conducted to assess multicomponent selectivity for pelletized Cu^{I}-MFU-4l in the presence of varying extents of humidity.

Preferential adsorption of O₂ over N₂ under anhydrous conditions was apparent by the delayed breakthrough of O₂ (ca. 25 min) compared to N₂ (ca. 10 min), indicative of an O₂-selective material. Triplicate measurements under anhydrous conditions with thermal reactivation (100° C.) under a He purge revealed no apparent changes in breakthrough time, indicating an excellent ability to regenerate without material degradation. Increasing relative humidity in 25% increments from anhydrous (0%) to saturated (100%) produced no obvious changes in performance with similar breakthrough times as compared to the anhydrous environment.

Such observations indicate water does not impede performance of the framework and compete for CuI binding against N₂ and O₂. Removal of volatiles at 50° C. allows for the complete removal of O₂ and N₂ with partial retention of water. Such mild regeneration conditions produces no substantial differences in performance for repeated runs, offering the opportunity for cycling without major temperature changes and full reactivation.

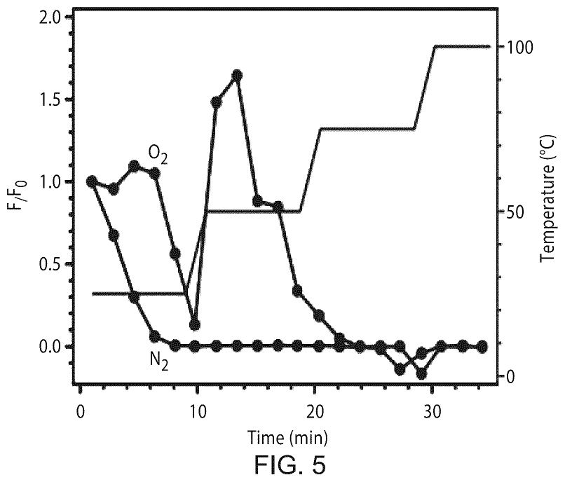

Similarly, purification of Ar by selective Ar coordination is observed in a 1:1 N₂: Ar mixture (FIG. 5), for example. Exploiting kinetic differences in desorption, it was observed that following complete N₂ desorption at 25° C., ramping to 50° C. affords rapid removal of O₂, facilitating a kinetic separation to afford N₂-free O₂. Desorption can be conducted entirely at 25° C. on longer timescales.

The technology described herein may be better understood with reference to the accompanying examples, which are intended for purposes of illustration only and should not be construed as in any sense limiting the scope of the technology described herein as defined in the claims appended hereto.

### Example 1

To demonstrate the breadth and functionality of the compositions and methods for oxygen separations, the framework Cu^{I}-MFU-4l and variants were synthesized. The synthesis of the porous Cu^{I}-MFU-4l material was illustrated through two synthetic pathways.

The framework Cu^{I}-MFU-4l was initially synthesized by reacting Zn₅Cl₄(btdd)₃ (MFU-4l) with excess CuCl₂ in dimethylacetamide at 60° C. under anhydrous conditions to give Cu^{II}(Cl)-MFU-4l. Subsequent anion exchange with lithium formate and thermolysis at 180° C. afforded Cu^{I}-MFU-4l, as supported by powder x-ray diffraction measurements. When prepared using this route, the Cu^{I}-MFU-4l has been shown to contain approximately 2.2 Cu ions, comprised of both Cu(I) and Cu(II) ions, per pentanuclear node.

The Cu(I) sites of Cu^{I}-MFU-4l are known to strongly bind H₂. Therefore, as a preliminary means of quantifying the active CuI sites, hydrogen adsorption isotherms were collected at 77 K and pressures ranging from 0 to 1.2 bar. At low pressures, the material exhibited a relatively steep H₂ uptake and achieved a capacity of approximately 1.2 mmol/g at 1 mbar H₂. Thereafter, the uptake becomes more gradual at higher pressures, indicative of non-specific physisorptive interactions with the framework. The low-pressure uptake at 1 mbar was lower than the predicted uptake of 1.86 mmol/g for a material with the assumed formula Cu_{2.2}Zn_{2.8}Cl_{1.8}(btdd)₃, assuming each Cu(I) site binds one equivalent of H₂. This result suggests ca. 35% of total Cu sites as inactive spectator Cu sites. Similar discrepancies between the measured capacity for strongly binding gases compared to expected theoretical uptake have been observed in previous reports pertaining to the gas sorption properties of Cu^{I}-MFU-4l.

Alternative routes to the synthesis of Cu^{I}-MFU-4l that would afford more Cu^{I} sites per node to furnish higher adsorption capacities were pursued. For clarity, the material Cu^{I}-MFU-4l is denoted as Cu_{X}-MFU-4l, in which X specifies the number of Cu sites per node as quantified by inductively coupled plasma optical emission spectroscopy (ICP-OES).

Following extensive optimization, it was observed that the treatment of Zn₅Cl₄(btdd)₃ with CuCl₂ (40 equiv.) in anhydrous dimethylsulfoxide at 60° C. increases the extent of Cu incorporation with 2.7 Cu ions per pentanuclear node based on energy-dispersive X-ray spectroscopy (EDX) and ICP-OES analysis. Two sequential additions of lithium formate monohydrate to this in situ accessed a Cu(II) intermediate material followed by thermolysis at 240° C. produces Cu_{2.7}-MFU-4l Cu_{2.7}Zn_{2.3}H_{0.4}Cl_{0.9}(btdd)₃) with substantially augmented uptake (2.09 mmol/g, 1 mbar H₂) compared to Cu_{2.2}-MFU-4l. This capacity corresponded to ca. 84% active CuI sites with the discrepancy attributed to spectator Cu^{II}-Cl sites due to incomplete formate exchange based on ¹H NMR and EPR studies. Surface area measurements for Cu_{2.7}-MFU-4l at 77 K with N₂ reveal a BET (Langmuir) surface area of 4160(40) m²/g (4500(20) m²/g), exceeding previously observed values.

The analogous synthetic procedure for Cu_{2.7}-MFU-4l using hydrated CuCl₂ and without exclusion of air or moisture affords a modest decrease in extent of CuII exchange with 1.96 mmol/g at 1.0 mbar H₂ in accessing Cu_{2.7}-MFU-4l, affording opportunities to prepare Cu^{I}-MFU-4l without anhydrous conditions.

In the optimization of the Cu^{I}-MFU-4l material, it was found that the treatment of Zn₅Cl₄(btdd)₃ with Cu^{I}Cl(SMe₂) (2×20 equiv.) in acetonitrile at 25° C. afforded Cu_{2.4}-MFU-4l (Cu_{2.4}Zn_{2.6}Cl_{1.6}(btdd)₃) following activation at 300° C. to remove coordinated acetonitrile. This approach provided a direct route to incorporate CuI into the periphery of MFU-4l with a more well-defined formula for the resultant material and fewer synthetic operations compared to the aforementioned Cu(II) reduction route.

The measured 77 K H₂ isotherm capacity (2.03 mmol/g, 1 mbar H₂) corresponded well to the theoretical capacity for 1 H₂/Cu^{I} site (>99% expected value), indicating all Cu sites in Cu_{2.4}-MFU-4l are active for small molecule binding. The BET (Langmuir) surface area of Cu_{2.4}-MFU-4l is 3820(30) m²/g (4190(20) m²/g), which suggests a lower porosity for Cu2.4-MFU-4l compared to Cu_{2.7}-MFU-4l and is in accord with the more sterically protruding Zn-Cl sites in Cu_{2.4}-MFU-4l compared to a mixture of Zn-Cl and less bulky Zn-H sites in Cu_{2.7}-MFU-4l. The Cu_{2.7}-MFU-4l for isotherms were used based on its increased H₂ capacity, and Cu_{2.4}-MFU-4l is employed for spectroscopic characterization due to its relative homogeneity in Zn site coordination environments and Cu oxidation states.

### Example 2

The synthesized Cu^{I}-MFU-4l materials were also evaluated by spectroscopic and computational characterization. The documented affinity of Cu^{I}-MFU-4l for O₂ prompted a spectroscopic investigation. Dosing Cu_{2.4}-MFU-4l with O₂ (8 mbar, 195 K) produced a rapid color change from bone-white to rose-pink with a unit cell contraction from 31.2090(14) Å to 31.0044(3) Å in the cubic Fm-3m space group as evident through Pawley refinement of the powder x-ray diffraction pattern, consistent with shortening of metal-ligand bonds from CuI oxidation.

A more subtle unit cell contraction from 31.2090(14) Å to 31.0997(11) Å upon N₂ dosing under identical conditions suggested the changes associated from O₂ dosing are not strictly due to structural distortions from substrate binding. Diffuse reflectance infrared Fourier transform spectroscopy (DRIFTS) measurements were conducted on Cu_{2.4}-MFU-4l with both ¹⁶O₂ and ¹⁸O₂ separately to eliminate vibrational features arising due to background framework perturbations. Dosing Cu_{2.4}-MFU-4l with ¹⁶O₂ (8 mbar) at 100 K induced growth of a new resonance at 1051 cm⁻¹ (993 cm⁻¹ with ¹⁸O₂, 990 cm⁻¹ calculated for a simple Harmonic oscillator), consistent with reported resonances for side-on (η²) Cu^{II}-superoxide motifs.

Increasing the temperature to 150 K produced the appearance of a secondary resonance at 1131 cm⁻¹ (1073 cm⁻¹ with ¹⁸O₂, 1066 cm⁻¹ calculated for a simple Harmonic oscillator), consistent with literature end-on (η¹) Cu^{II}- superoxide motifs. Warming the sample to 25° C. in the presence of O₂ produced an evident color change from rose-pink to brown-gray with retention of both η²-O₂ and η¹-O₂ resonances. Upon evacuation to remove adsorbed O₂, a reversion to the initial bone-white framework was observed. Subsequent cooling to 100 K under O₂ (45 mbar) produced a color reversal to rose-pink with a disappearance of the η¹-O₂ resonance. This suggests against defect sites or a secondary coordination site responsible for O₂ binding and instead is consistent with a thermodynamic equilibrium between the side-on and end-on O₂ modes on identical Cu(I) site, favoring the side-bound mode.

DRIFTS measurements on air-exposed Cu_{2.4}-MFU-4l to reveal a new resonance at 2242 cm⁻¹ attributed to N₂ coordination with partial decrease in intensity and growth of the 1051 cm⁻¹ resonance upon prolonged air exposure, indicating a thermodynamic preference for O₂ coordination over N₂ coordination.

Magnetometry measurements on O₂-dosed Cu_{2.4}-MFU-4l further supported a temperature-dependent binding in which minimal magnetic response was observed below 200 K (<0.2 χ_{M}T), followed by an increase in moment to 300 K (0.5 χ_{M}T), consistent with an equilibrium between the S=0 and S=1 species in which the higher spin state is partially accessed upon warming.

An equilibrium of the O₂ binding mode was supported through density functional theory (DFT) calculations, revealing an energetic preference for the η²-O₂ binding mode (ΔH=−54 kJ mol⁻¹) over the η¹-O₂ binding mode (ΔH=−41 kJ mol⁻¹). Calculated bond lengths suggest electron transfer between Cu and O₂ for the η²-O₂ (1.28 Å) and η¹-O₂ (1.24 Å) binding modes by comparison of the bound O₂ bond length to that of gaseous O₂ (1.21 Å). Together these data suggest a Cu^{II}(O₂ ^{•-}) assignment may be the most appropriate electronic structure assignment of O₂ to Cu^{I}-MFU-4l, indicating partial electron transfer from the Cu site to the bound O₂ motif.

### Example 3

To further demonstrate the capabilities of the Cu_{2.7}-MFU-4l material, isothermal and isobaric characterizations were conducted. Gas adsorption isotherms for Cu_{2.7}-MFU-4l were collected at variable temperatures to measure single-component capacities. The isotherms of O₂, N₂, and Ar collected at 25° C. reveal Cu_{2.7}-MFU-4l adsorbs more O₂ than to N₂ and Ar for all pressures below 1 bar. At the fractional composition of air (ca. 210 mbar O₂, 780 mbar N₂, 9 mbar Ar), the O₂ capacity (1.51 mmol/g) exceeds that of N₂ (1.30 mmol/g) and of Ar (<0.01 mmol/g). Whereas low temperature Ar isotherms (170 K to 190 K) could be simultaneously modelled with a single-site Langmuir-Freundlich model, simultaneous fitting of three O₂ and N₂ isotherms between 288 K and 308 K required dual-site Langmuir-Freundlich models, suggesting both strong gas sorption to the CuI site as well as secondary non-specific physisorptive interactions between the framework and the adsorbates.

Isosteric heats of adsorption (Qst), as calculated by the Clausius-Clapeyron equation for O₂ (−56.8(1) kJ/mol), exceed those of N₂ (−38.9(4) kJ/mol) and Ar (−10.9(1) kJ/mol, FIG. 1), indicating O₂ has the highest affinity for the framework of the three adsorbates. Similar Ar heats of adsorption values (−10 to −12 kJ/mol) have been observed for zeolites and activated carbons, suggesting weak framework interactions. Whereas the Ar binding strength remained essentially constant with respect to loading, both O₂ and N₂ exhibited a gradual decline in binding strength as CuI sites become more saturated and binding to the secondary sites becomes more prevalent.

Selectivity values calculated with ideal adsorption solution theory (IAST) suggest enhancement of O₂ in the adsorbed phase compared to the concentration of O₂ in air. An O₂ /N₂ IAST value of 10 (corresponding to 72% adsorbed phase purity) was predicted at 298 K for an inlet stream of 21% O₂, while lowering the temperature to 288 K affords a slight increase in purity (74% adsorbed phase purity) as shown in FIG. 2. It should be noted that adsorption and desorption kinetic differences arising from electron transfer for redox-active O₂ and redox-inactive N₂ binding to the Cu^{I} site may result in deviations from expectations for multicomponent mixtures, limiting the applicability of IAST to realistic conditions, which is observed in breakthrough measurements.

Single-component Ar isotherms at 25° C. reveal minimal uptake with 0.22 mmol/g uptake at 1 bar, and the corresponding IAST predictions for both N2/Ar and O₂/Ar reveal Cu_{2.7}-MFU-4l may also be appropriate to remove N₂ and O₂ impurities for Ar purification (FIG. 3). A minimal affinity for other anhydrous trace components of air is anticipated from previous isotherm measurements for gases such as CO₂.

No change in the powder X-ray diffraction pattern was observed upon exposure of Cu_{2.7}-MFU-4l to air at ambient temperature for three months, prompting an investigation of water stability. Single-component water isotherms of Cu_{2.7}-MFU-4l at 25° C. reflected an enhanced hydrophobicity compared to MFU-4l, reflective of the low affinity for water at the exposed CuI sites as seen in FIG. 4. Whereas N₂, O₂, and Ar adsorption isotherms of Cu_{2.7}-MFU-4l were readily completed within several hours, the corresponding water isotherm required multiple days, indicative of sluggish kinetics for water coordination. In contrast to zeolites and MOFs with exposed hydrophilic functionality with onset capillary condensation at low partial pressures of H₂O, Cu_{2.7}-MFU-4l adsorbs water with linear uptake until 1.11 mmol/g at 45% relative humidity (14.3 mbar) with a subsequent gradual increase to 4.99 mmol/g at 80% relative humidity (25.2 mbar). Subsequent desorption proceeded with hysteresis, attributed to formation of water clusters within the framework pores. The framework retained crystallinity following water exposure as ascertained by powder X-ray diffraction.

In contrast, single-component measurements on Cu_{2.2}-MFU-4l with a lower density of Cu sites reveals steep uptake between 15 mbar and 25 mbar resulting in 17.11 mol/g at 92% relative humidity (29.4 mbar), indicative of capillary condensation (FIG. 4). The Cu_{2.2}-MFU-4l material undergoes irreversible decomposition as inferenced through negative hysteresis on desorption, the absence of subsequent H₂ binding at 77 K and low H₂ partial pressures, and diminished crystallinity through powder x-ray diffraction. Such data reveal the higher Cu^{I} loading, increased surface area, and replacement of peripheral polar Zn-formate/chloride motifs with zinc-hydride motifs augments water stability by impeding capillary condensation. Increasing the temperature to 30° C. decreased water uptake for Cu_{2.7}-MFU-4l at all measured pressures, indicating a strong water response of Cu_{2.7}-MFU-4l to temperature as shown in FIG. 4.

Cycling measurements with Cu2.7-MFU-4l revealed rapid adsorption and desorption kinetics for O₂. Thermogravimetric analysis with brief adsorption with desiccated air (5 min exposure time) and desorption under simulated vacuum with an Ar purge (10 min exposure time) reveal >99.5% capacity retention over 120 cycles, indicating robustness to adsorption and desorption in a simulated pressure swing adsorption process.

Similarly, partial O₂ desorption could be achieved through a thermal swing adsorption process by heating the framework to 100° C. for 30 seconds with majority capacity retention (>95%) over 40 cycles with the slight capacity decrease attributable due to the highly oxidizing conditions. Stability of the framework under O₂ was observed until 280° C., followed by a rapid mass loss consistent with ligand oxidation, compared to an analogous rapid mass loss delayed to 400° C. under N₂.

### Example 4

Kinetic adsorption and desorption measurements of O₂ and N₂ with Cu_{2.7}-MFU-4l at 288 K, 298 K, and 308 K were conducted to assess relative rates and tabulate activation barriers. For each temperature, measurements were conducted at various dosing concentrations. These pressures corresponded to initial dose amounts of 0.5 mmol/g, 1.0 mmol/g, 5.0 mmol/g, and 10.0 mmol/g for both O₂ and N₂. Rapid adsorption kinetics for both O₂ and N₂ were observed with equilibration occurring within 100 seconds. It was observed that N₂ equilibration occurs marginally more rapidly than O₂ equilibration with enhanced kinetics for both species at elevated temperatures. Such results were noteworthy insofar as O₂ binding to Cu^{I} proceeds with electron transfer whereas N₂ binds to Cu^{I} without electron transfer, noting that electron transfer in the absence of a solvating dielectric typically incurs sluggish kinetics and large reorganization penalties.

Kinetic differences between O₂ and N₂ equilibration times are minimized upon dosing with higher pressures, approaching diffusion-controlled timescales as observed for Ar kinetic measurements. Modelling rate constants for 1.0 mmol g⁻¹ dosing with the Lagergren equation returned satisfactory least-squares linear regression fits of experimental data (R²>0.99) with a pseudo-first order rate law model. Similar activation barriers were calculated for O₂ adsorption (Eₐ=10(1) kJ mol⁻¹) and N₂ adsorption (Eₐ=12(1) mol⁻¹) through fitting these data to the Arrhenius equation up to three half-lives (3t_{1/2}). Identical activation barriers were calculated for more dilute dosing values of 0.5 mmol g⁻¹.

In contrast to adsorption measurements, O₂ desorption under reduced pressure following 1.0 mmol/g dosing at 298 K was notably more sluggish than N₂ desorption from Cu_{2.7}-MFU-4l with kinetic differences exacerbated upon cooling to 288 K. Analogous application of a first order Langmuir rate law model revealed large differences in activation barriers between O₂ desorption (Eₐ=45(1) kJ/mol) and N₂ desorption (Eₐ=30(1) kJ/mol. Diffusive time constant (D_{c}/r_{c}²) calculations reveal more rapid diffusion values for N₂ (ca. 1 to 2×10⁻²s⁻¹) relative to O₂ (ca. 5 to 7×10⁻³s⁻¹), attributed to a weaker binding affinity of N₂ toward the framework. These relatively large values were indicative of rapid diffusion kinetics attributed to the large pore aperture and in contrast to the gas diffusion time constants tabulated for the smaller pore variant MFU-4.

These data taken together revealed similar adsorption kinetics with marked differences in desorption kinetics, attributed to differences in activation barriers, potentially facilitating kinetic desorption favoring high-purity O₂.

Breakthrough measurements at 25° C. with a compressed air inlet stream (2 mL min⁻¹) were conducted to assess multicomponent selectivity for pelletized Cu_{2.7}-MFU-4l in the presence of varying extents of humidity. Gas chromatography was employed to quantify O₂ and N₂, which resulted in a suboptimal signal-to-noise ratio. Preferential adsorption of O₂ over N₂ under anhydrous conditions is apparent by the delayed breakthrough of O₂ (ca. 25 min) compared to N₂ (ca. 10 min), indicative of an O₂-selective material.

Triplicate measurements under anhydrous conditions with thermal reactivation (150° C.) under a He purge revealed no apparent changes in breakthrough time, indicating the ability to regenerate without material degradation. Increasing relative humidity in 25% increments from anhydrous (0%) to saturated (100%) affords no obvious changes in performance with similar breakthrough times as compared to the anhydrous environment.

Measured average capacity values (1.17(7) mmol/g O₂, 1.65(29) mmol/g N₂) indicate an enhancement in O₂ purity in the adsorbed phase compared to that of ambient air. Such observations indicate water is adsorbed in the framework and neither impedes performance nor competes for Cu^{I} binding against N₂ and O₂ on the breakthrough timescale. Purging the material with He at 50° C. results in the complete removal of O₂ and N₂ with partial retention of water. Such mild regeneration conditions produced no apparent differences in O₂ and N₂ separation performance for repeated runs, offering the opportunity for cycling without major temperature changes and full material reactivation. Exploiting kinetic differences in desorption, it was observed that following complete N₂ desorption at 25° C., ramping to 50° C. produces rapid removal of O₂, facilitating a kinetic separation to afford N₂-free O₂ as shown in FIG. 5. Desorption could be conducted entirely at 25° C., albeit with relatively sluggish kinetics, indicating a tradeoff between desorption rates and thermal input for regeneration.

It was further observed that the Cu_{2.7}-MFU-4l material is selective for N₂ over Ar in an equal composition stream, indicating Cu_{2.7}-MFU-4l may have potential to remove N₂ and O₂ impurities from Ar streams with facile regeneration.

### Example 5

Density functional calculations were employed to examine the binding of N₂, O₂, and H₂O to the exposed Cu(I) site in Cu^{I}-MFU-4l, modelled as Cu₂Zn₃Cl₂(ta)₆ (HTa=1,2,3-triazole) with a single adsorbate binding to the exposed CuI site for computational ease.

To interpret the binding energy in chemically intuitive terms, energy decomposition analysis was conducted to yield values attributable to electrostatic interactions, Pauli repulsion, dispersion, polarization, and charge transfer. The relative charge transfer contribution to binding in O₂ is markedly stronger in comparison to N₂. This charge transfer mechanism is dominated by the back-donation from Cu(I) to O₂. The difference observed in the measured adsorption enthalpies between N₂ and O₂ is thus attributable to the metal-O₂ orbital interactions facilitated by the back-donation from the Cu^{I} site.

Conversely, water exhibits weaker binding at the open metal site, as opposed to N₂ and O₂. Despite polarized by Cu(I), the charge transfer term for water coordination is diminutive, thereby leading to predicted much weaker binding enthalpy of −20.5 kJ/mol, in contrast to stronger binding −26.3 kJ/mol for N₂ and −59.3 kJ/mol for O₂ coordination. Weak coordination of water may similarly account for sluggish kinetics as observed for isothermal measurements, contrasting N₂ and O₂ kinetics which display stronger binding and enhanced kinetics.

These data demonstrate the feasibility of the sequestration of O₂ from ambient air in the presence of water with mild regeneration conditions through employment of an optimized Cu^{I}-based metal-organic framework Cu_{2.7}-MFU-4l. Rapid adsorption kinetics facilitate similar rates for O₂ and N₂ sequestration, despite differences in the extent of electron transfer between the two adsorbates, and differing desorption kinetics provide avenue for a kinetic separation following adsorption from a multicomponent stream.

Kinetic differences are further reflected in large differences in activation barriers for desorption as calculated from application of the Arrhenius equation to a first-order Langmuir rate law model. The adsorption breakthrough profiles of Cu_{2.7}-MFU-4l for O₂ and N₂ are invariant to humidity, suggesting co-adsorbed water does not bind to the exposed CuI sites in these multicomponent mixtures.

Further, the observed preferential adsorption of O₂ and N₂ over Ar, provides opportunities for Ar purification and provides benefits over existing N₂-selective MOFs, which contain low-valent V(II) sites that are susceptible to irreversible oxidization by O₂ or exhibit a high-water affinity through Lewis acidic Cr(III) sites which may block Cr sites from engaging in N₂ coordination.

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A composition, comprising a metal-organic framework Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin).

The composition of any preceding or following implementation, comprising a metal-organic framework Cu_{2.2}-MFU-4l (Cu_{2.2}Zn_{2.8}Cl_{1.8}(btdd)₃).

The composition of any preceding or following implementation, comprising a metal-organic framework Cu_{2.4}-MFU-4l (Cu_{2.4}Zn_{2.6}Cl_{1.6}(btdd)₃)

The composition of any preceding or following implementation, comprising a metal-organic framework Cu_{2.7}-MFU-4l, (Cu_{2.7}Zn_{2.3}H_{0.4}Cl_{0.9}(btdd)₃).

The composition of any preceding or following implementation, comprising a metal-organic framework Cu_{X}-MFU-4l, where X=2.2 to 2.7.

A method for removing N₂ and O₂ impurities in an argon gas stream, the method comprising (a) providing a stream of argon gas with N₂ and O₂ impurities for separation; (b) adsorbing O₂ and N₂ from the stream of gases on a porous metal-organic framework (MOF) adsorbent, the framework comprising Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin); (c) collecting the purified Ar gas stream; (d) releasing the adsorbed O₂ and N₂ from the framework; and (e) recovering the released gases and regenerating the framework.

The method of any preceding or following implementation, further comprising controlling temperature and pressure of the stream of gases at a time of adsorption.

The method of any preceding or following implementation, wherein the adsorption temperature is controlled to 25° C. and the pressure is controlled to below 1 bar.

The method of any preceding or following implementation, further comprising reducing water concentration of the stream of gases prior to adsorption by the metal organic framework.

The method of any preceding or following implementation, wherein the metal organic framework comprises the metal-organic framework Cu_{2.2}-MFU-4l (Cu_{2.2}Zn_{2.8}Cl_{1.8}(btdd)₃).

The method of any preceding or following implementation, wherein the metal organic framework comprises a metal-organic framework Cu_{2.4}-MFU-4l (Cu_{2.4}Zn_{2.6}Cl_{1.6}(btdd)₃) The method of any preceding or following implementation, wherein the metal organic framework comprises a metal-organic framework Cu_{2.7}-MFU-4l, (Cu_{2.7}Zn_{2.3}H_{0.4}Cl_{0.9}(btdd)₃).

The method of any preceding or following implementation, wherein the metal organic framework comprises a metal-organic framework Cu_{X}-MFU-4l, where X=2.2 to 2.7.

A method for efficient recovery of high-purity O₂ from unpurified, ambient air, the method comprising: (a) providing a volume of ambient air for separation; (b) adsorbing O₂ from the ambient air on a porous metal-organic framework (MOF) adsorbent, the framework comprising Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin); (c) releasing the adsorbed O₂ from the framework; and (d) collecting the released a high-purity O₂ gas.

The method of any preceding or following implementation, further comprising releasing any N₂ gas that has been co-adsorbed with the O₂ with a secondary release.

The method of any preceding or following implementation, further comprising controlling temperature and pressure of the volume of ambient air at a time of adsorption.

The method of any preceding or following implementation, wherein the adsorption temperature is controlled to 25° C. and the pressure is controlled to below 1 bar.

The method of any preceding or following implementation, further comprising reducing water concentration of the stream of gases prior to adsorption by the metal organic framework.

The method of any preceding or following implementation, wherein the metal organic framework comprises a metal-organic framework Cu_{X}-MFU-4l, where X=2.2 to 2.7.

The method of any preceding or following implementation, wherein the metal organic framework comprises a metal-organic framework Cu_{2.7}-MFU-4l, (Cu_{2.7}Zn_{2.3}H_{0.4}Cl_{0.9}(btdd)₃).

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C . . . ” within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment,” “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1% , less than or equal to ±0.5%, less than or equal to ±0.1% , or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A composition, comprising:
a metal-organic framework Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin).

2. The composition of claim 1, comprising:
a metal-organic framework Cu_{2.2}-MFU-4l (Cu_{2.2}Zn_{2.8}Cl_{1.8}(btdd)₃).

3. The composition of claim 1, comprising:
a metal-organic framework Cu_{2.4}-MFU-4l (Cu_{2.4}Zn_{2.6}Cl_{1.6}(btdd)₃).

4. The composition of claim 1, comprising:
a metal-organic framework Cu_{2.7}-MFU-4l, (Cu_{2.7}Zn_{2.3}H_{0.4}Cl_{0.9}(btdd)₃).

5. The composition of claim 1, comprising:
a metal-organic framework Cu_{X}-MFU-4l, where X=2.2 to 2.7.

6. A method for removing N₂ and O₂ impurities in an argon gas stream, the method comprising:
(a) providing a stream of argon gas with N₂ and O₂ impurities for separation;
(b) adsorbing O₂ and N₂ from the stream of gases on a porous metal-organic framework (MOF) adsorbent, the framework comprising Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin);
(c) collecting the purified Ar gas stream;
(d) releasing the adsorbed O₂ and N₂ from the framework; and
(e) recovering the released gases and regenerating the framework.

7. The method of claim 6, further comprising:
controlling temperature and pressure of the stream of gases at a time of

8. The method of claim 7, wherein the adsorption temperature is controlled to 25° C. and the pressure is controlled to below 1 bar.

9. The method of claim 6, further comprising:
reducing water concentration of the stream of gases prior to adsorption by the metal organic framework.

10. The method of claim 6, wherein the metal organic framework comprises:
a metal-organic framework Cu_{2.2}-MFU-4l (Cu_{2.2}Zn_{2.8}Cl_{1.8}(btdd)₃).

11. The method of claim 6, wherein the metal organic framework comprises:
a metal-organic framework Cu_{2.4}-MFU-4l (Cu_{2.4}Zn_{2.6}Cl_{1.6}(btdd)₃).

12. The method of claim 6, wherein the metal organic framework comprises:
a metal-organic framework Cu_{2.7}-MFU-4l, (Cu_{2.7}Zn_{2.3}H_{0.4}Cl_{0.9}(btdd)₃).

13. The method of claim 6, wherein the metal organic framework comprises:
a metal-organic framework Cu_{X}-MFU-4l, where X=2.2 to 2.7.

14. A method for efficient recovery of high-purity O₂ from unpurified, ambient air, the method comprising:
(a) providing a volume of ambient air for separation;
(b) adsorbing O₂ from the ambient air on a porous metal-organic framework (MOF) adsorbent, the framework comprising Cu^{I}-MFU-4l (Cu_{X}Zn₅₋ₓ(OCHO/Cl)₄₋ₓ(btdd)₃; H₂btdd=bis(1H-1,2,3-triazolo[4,5-b],[4′,5′-i])dibenzo[1,4]dioxin);
(c) releasing the adsorbed O2 from the framework; and
(d) collecting the released a high-purity O₂ gas.

15. The method of claim 14, further comprising:
releasing any N₂ gas that has been co-adsorbed with the O₂ with a secondary release.

16. The method of claim 14, further comprising:
controlling temperature and pressure of the volume of ambient air at a time of adsorption.

17. The method of claim 16, wherein the adsorption temperature is controlled to 25° C. and the pressure is controlled to below 1 bar.

18. The method of claim 14, further comprising:
reducing water concentration of the stream of gases prior to adsorption by the metal organic framework.

19. The method of claim 14, wherein the metal organic framework comprises:
a metal-organic framework Cu_{X}-MFU-4l, where X=2.2 to 2.7.

20. The method of claim 19, wherein the metal organic framework comprises:
a metal-organic framework Cu_{2.7}-MFU-4l, (Cu_{2.7}Zn_{2.3}H_{0.4}Cl_{0.9}(btdd)₃).
